(19) United States
(12) Patent Application Publication
(10) Pub. No.: US 2013/0238615 A1
(43) Pub. Date: Sep. 12, 2013

(54) INFORMATION MANAGEMENT APPARATUS AND INFORMATION MANAGEMENT METHOD

(71) Applicant: FUJITSU LIMITED, Kawasaki-shi (JP)

(72) Inventor: Akiko HAYASHI, Kawasaki (JP)

(21) Appl. No.: 13/743,032

(22) Filed: Jan. 16, 2013

(30) Foreign Application Priority Data
Mar. 8, 2012 (JP) 2012-052284

(51) Int. Cl. G06F 17/30

(52) U.S. Cl. CPC G06F 17/30554
USPC 707/727

(57) ABSTRACT

An information management apparatus, including an obtainment unit to obtain identification information for identifying first viewed information when a viewing unit has displayed the first viewed information, an extraction unit to extract a frequently appearing character string included in the first viewed information, a registration unit to add route information to identification information for identifying second viewed information in an associated manner, a first output unit to output to the display unit first display information for displaying a first selection unit that lists favorites information including route information including a frequently appearing character string for each frequently appearing character string; and, a second output unit to output to the display unit second display information for displaying favorites information including route information including a frequently appearing character string that corresponds to a selected first selection unit.

### CROSS-REFERENCE TO RELATED APPLICATION

This application is based upon and claims the benefit of priority of the prior Japanese Patent Application No. 2012-052284, filed on Mar. 8, 2012, the entire contents of which are incorporated herein by reference.

### FIELD

The embodiments described herein are related to an information management apparatus and information management method for managing information used through browsers or the like.

### BACKGROUND

As a conventional technique, WEB browsers have a function of registering as favorites information WEB pages that each user prefers. Favorites information includes the titles and URLs (Uniform Resource Locators) of WEB pages, etc. Thereby, users can view WEB pages registered as favorites information as needed after the registration.

As a technique related to the above technique, an information searching apparatus that searches for information related to properties of image data is known.

Also, an information searching know-how management system including an information obtaining device that obtains necessary information by searching for the information on the Internet so as to generate search history information representing the search history, and an information sharing management device that manages the obtained necessary information and the search history information in an associated manner so that they can be shared are known.

Patent Document 1: Japanese Laid-open Patent Publication No. 2006-285526

Patent Document 2: Japanese Laid-open Patent Publication No. 2007-128367

### SUMMARY

According to an aspect of the embodiments, an information management apparatus includes elements as described below.

An obtainment unit obtains identification information for identifying first viewed information when a viewing unit that obtains viewed information published on a network so as to output the viewed information to a display unit has displayed the first viewed information.

An extraction unit extracts a frequently appearing character string included in the first viewed information.

A storage process unit stores, in a storage unit, route information on the first viewed information that includes the identification information for identifying the first viewed information and the frequently appearing character string included in the first viewed information.

A registration unit adds route information to identification information for identifying second viewed information in an associated manner when the second viewed information being output from the viewing unit is to be registered as favorites information.

A first output unit outputs to the display unit first display information for displaying a first selection unit that lists favorites information including route information including a frequently appearing character string for each frequently appearing character string included in the route information of the favorites information.

A second output unit outputs to the display unit second display information for displaying, in a listed manner, favorites information including route information including a frequently appearing character string that corresponds to a selected first selection unit when the first selection unit has been selected.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates the outline of an information management unit 100 according to an example;

FIG. 2 explains the outline of an information management apparatus 210 according to another example;

FIG. 3 illustrates an example of favorites information 300;

FIG. 4 illustrates the outline of the process performed by a browser monitoring unit 211;

FIGS. 5A and 5B illustrates the outline of the process performed by a favorites information management unit 212;

FIG. 6 is a flowchart explaining operations of the browser monitoring unit 211;

FIG. 7 is a flowchart explaining operations of the favorites information management unit 212;

FIG. 8 is a flowchart explaining operations of the favorites information management unit 212; and

FIG. 9 illustrates an example of a configuration of the information management apparatus 210.

### DESCRIPTION OF EMBODIMENTS

When a WEB browser is used for a long time, the number of pieces of registered favorites information increases. In such a case, it takes time to find a desired piece of favorites information unless the pieces of favorites information are sorted out. As a result of this, the usability of the favorites information becomes lower, which is problematic. Also, when the number of pieces of registered favorites information has increased, the sorting out of such pieces of information also becomes troublesome. Further, old favorites information sometimes include pieces of information to which links have become broken or pieces of information that have become outdated. In such a case, a search may have to be performed again for pages containing content similar to such old favorites information.

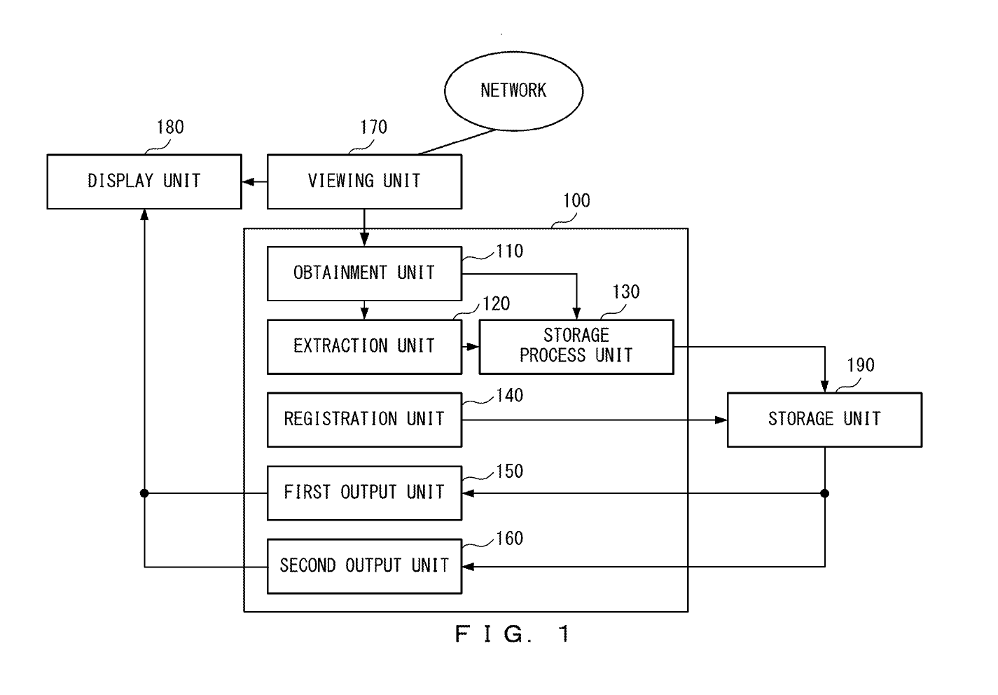

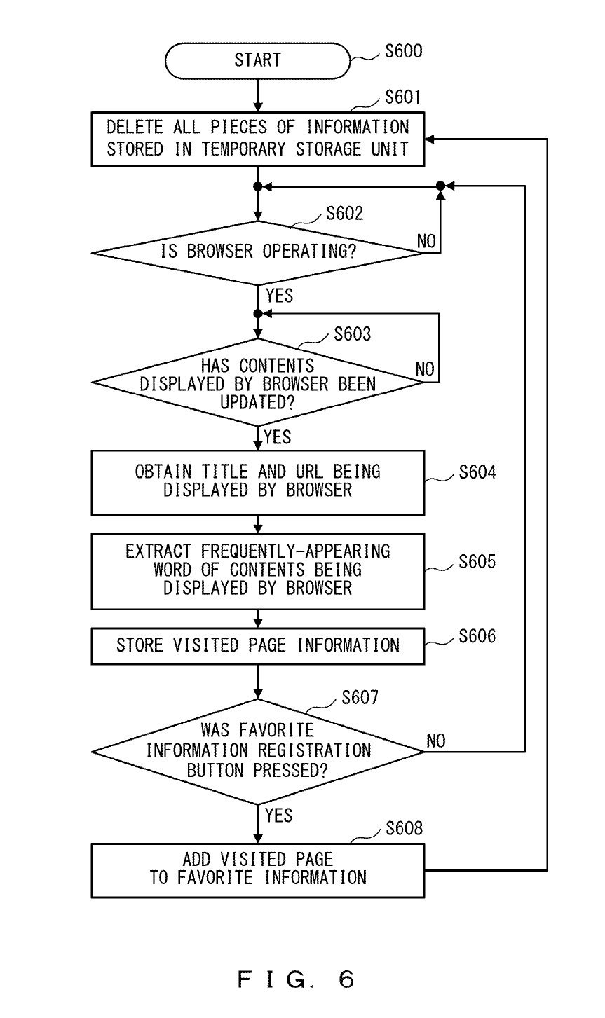

Hereinafter, an example of embodiments of the present invention will be explained by referring to FIGS. 1 through 9. Note that the embodiments explained below are only exemplary, and are not intended to exclude various modifications or applications of techniques that are not described below. In other words, the embodiments can be implemented with various modifications such as combining the respective examples without departing from the spirit of the embodiments. Also, the process sequences explained in the form of flowcharts in FIGS. 6 through 8 are not intended to limit the order of those processes. Thus, as a matter of course, when it is possible, the order of the processes may be changed.

### EXAMPLES

FIG. 1 illustrates an outline of an information management unit 100 according to an example.

The information management unit 100 is an information processing apparatus that includes an obtainment unit 110, an extraction unit 120, a storage process unit 130, a registration unit 140, a first output unit 150, and a second output unit 160. The obtainment unit 110, the extraction unit 120, the storage process unit 130, the registration unit 140, the first output unit 150, and the second output unit 160 may be implemented by making the information management unit 100 execute a prescribed program.

The obtainment unit 110 obtains identification information for identifying first viewed information when it has been detected that a viewing unit 170 has displayed the first viewed information. The viewing unit 170 obtains arbitrary viewed information published on networks such as the Internet, and outputs the obtained information to a display unit 180 to display it. A browser for viewing WEB pages, and the like, for example, can be used as the viewing unit 170. The viewing unit 170 can operate on the information management unit 100 or on other information processing apparatuses (not illustrated) connected to the information management unit 100 through a network.

The extraction unit 120 extracts a frequently appearing character string included in the first viewed information. Frequently appearing character strings are character strings that appear frequently among character strings included in viewed information. The extraction unit 120 can extract character strings appearing at least a prescribed number of times among character strings included in viewed information. It is also possible to limit extraction target character strings to a particular character string.

The storage process unit 130 stores in a storage unit 190 first-viewed-information related route information that includes identification information for identifying the first viewed information and a frequently appearing character string included in the first viewed information. Information for identifying viewed information can include location information specifying the location of the viewed information such as, for example, the URL or the title of the viewed information. Also, as the storage unit 190, not only a storage device such as a magnetic disk device but also, for example, volatile memory such as RAM (Random Access Memory) or the like and non-volatile memory such as EEPROM (Electrically Erasable Programmable Read-Only Memory) or the like can be used. Also, the storage unit 190 can also use a storage device connected through a network such as the Internet, i.e., so-called online storage in the cloud.

The registration unit 140 adds one or more pieces of route information to identification information for identifying the second viewed information in an associated manner when the second viewed information output from the viewing unit 170 is to be registered as favorites information.

For each frequently appearing character string included in route information of favorites information, the first output unit 150 outputs, to the display unit 180, first display information displaying a first selection unit that selects a list display of favorites information including route information including the frequently appearing character string, and displays the information. When the first display information is displayed on the display unit 180, the user can select a first selection unit that he or she likes by using an input unit such as a mouse or the like provided by the information management unit 100.

When an arbitrary first selection unit has been selected, the second output unit 160 outputs to the display unit 180 a second display information that displays, in a listed manner, favorites information including route information including a frequently appearing character string that corresponds to the selected first unit, and displays the information.

Note that the first output unit 150 may output first display information directly to the display unit 180 so as to display the information as indicated by an arrow in FIG. 1. However, the scope of the present invention is not limited to this example. For example, it is also possible to employ a configuration in which the first output unit 150 outputs first display information to the viewing unit 170 so that the viewing unit 170 makes the display unit 180 display the first display information. Similarly, while the second output unit 160 may output second display information directly to the display unit 180 so as to make it display the information as indicated by an arrow in FIG. 1, this example does not limit the scope of the present invention. For example, it is also possible to employ a configuration in which the second output unit 160 outputs second display information to the viewing unit 170 so that the viewing unit 170 makes the display unit 180 display the second display information. Also, while the display unit 180 may be connected to the information management unit 100 directly, it may also be connected to the information management unit 100 through a network such as the Internet in a communicable manner.

As described above, for each frequently appearing character string included in route information of favorites information, the information management unit 100 outputs, to the display unit 180, first display information displaying a first selection unit that selects a list display of favorites information including route information including the frequently appearing character string, and displays the information. When an arbitrary first selection unit has been selected, the information management unit 100 outputs to the display unit 180 second display information that displays in a listed manner favorites information including route information including a frequently appearing character string corresponding to the selected first selection unit, and displays the information.

In this example, frequently appearing character strings included in viewed information express the abstract, characteristics, and the like of the viewed information. Accordingly, users are enabled to easily obtain desired favorites information by selecting a first selection unit corresponding to a frequently appearing character string that seems to express viewed information registered as desired favorites information even when the number of pieces of favorites information has increased.

### <Another Example>

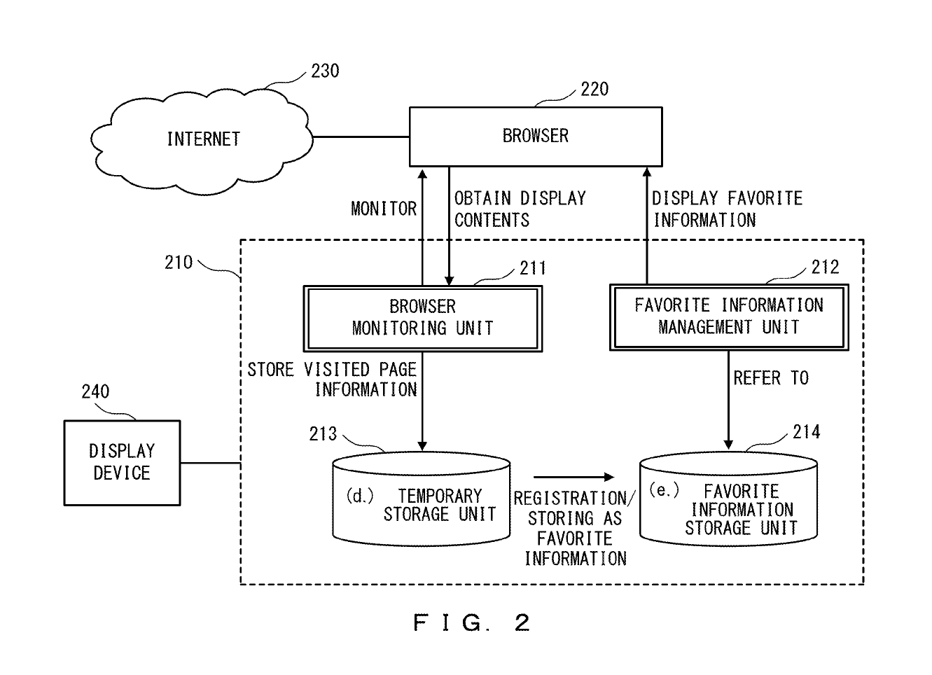

FIG. 2 explains the outline of an information management apparatus 210 according to another example.

The information management apparatus 210 includes a browser monitoring unit 211, a favorites information management unit 212, a temporary storage unit 213, and a favorites information storage unit 214. The information management apparatus 210 manages information handled by a browser 220.

The browser 220 is WEB-page viewing software that uses a protocol such as HTTP (HyperText Transfer Protocol) or the like so as to obtain a WEB page published by an information processing apparatus connected to the browser 220 through the Internet 230, outputs the obtained WEB page to a display device 240, and displays the page. The browser 220 may include a search engine that searches for WEB pages including a character string corresponding to a keyword. The browser 220 may operate on the information management apparatus 210, and also may operate on a different information processing apparatus (not illustrated) connected to the information management apparatus 210 through a network such as the Internet 230. Also, data or the like output from the browser 220 or the information management apparatus 210 may be displayed on the display device 240 connected to the information management apparatus 210, or may be displayed on, for example, a different display device (not illustrated) connected to the information management apparatus 210 through a network such as the Internet 230.

The browser monitoring unit 211 monitors operations of the browser 220. For example, the browser monitoring unit 211 periodically obtains, from the browser 220, the URLs of WEB pages that the browser 220 outputs to the display device 240 to display. When the browser monitoring unit 211 has detected a change in the URL of a WEB page that the browser 220 outputs to the display device 240 to display, the browser monitoring unit 211 determines that display contents of a WEB page that the browser 220 outputs to the display device 240 to display have been updated. In such a case, the browser monitoring unit 211 obtains the updated display contents of the WEB page from the browser 220. The browser monitoring unit 211 stores the URL and the title of the updated WEB page, link information included in the WEB page, and the like in the temporary storage unit 213 as visited page information. Further, the browser monitoring unit 211 extracts frequently appearing words from character strings included in the display contents of the updated WEB page, and adds the extracted words to the visited page information.

Also, the browser monitoring unit 211 detects, for example, that a favorites registration button provided to the browser 220 has been pressed. When this favorites registration button has been pressed, the browser 220 stores, in the favorites information storage unit 214 as favorites information, the WEB page being displayed by the browser 220, i.e., the WEB page that the browser 220 is currently outputting to the display device 240 to display it. When the browser monitoring unit 211 has detected that the favorites registration button was pressed, it adds, to favorites information, search route information including the visited page information stored in the temporary storage unit 213, in such a manner that the search route information is associated with the favorites information. Note that pressing of a “button” herein means selection by a user of a “button” displayed on the display device 240 by using an input device 903 such as, for example, a mouse.

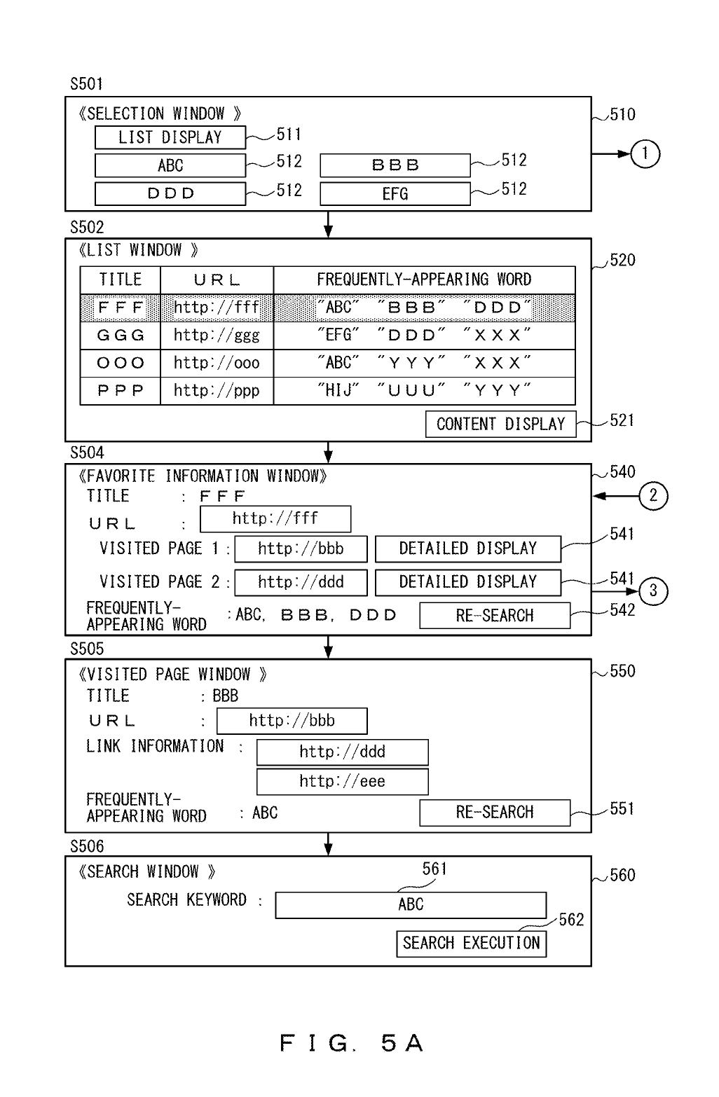

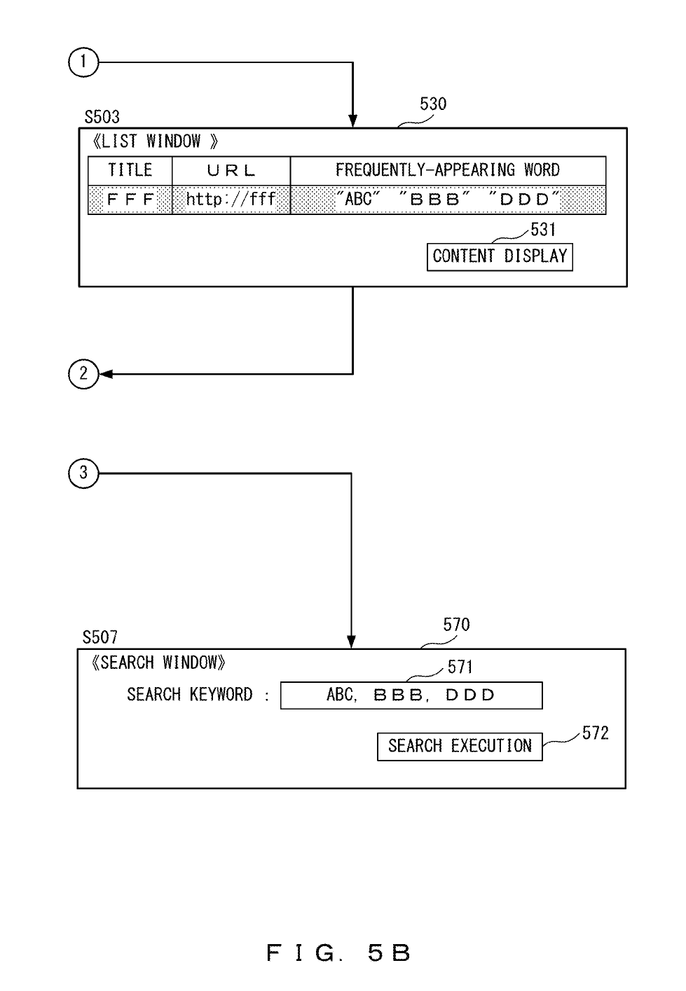

The favorites information management unit 212 provides to users an interface for managing favorites information stored in the favorites information storage unit 214. For example, the favorites information management unit 212 displays, on the display device 240 and in various forms, the contents of favorites information stored in the favorites information storage unit 214, as needed. Examples of windows that the favorites information management unit 212 outputs to the display device 240 and displays are illustrated in FIGS. 5A and 5B.

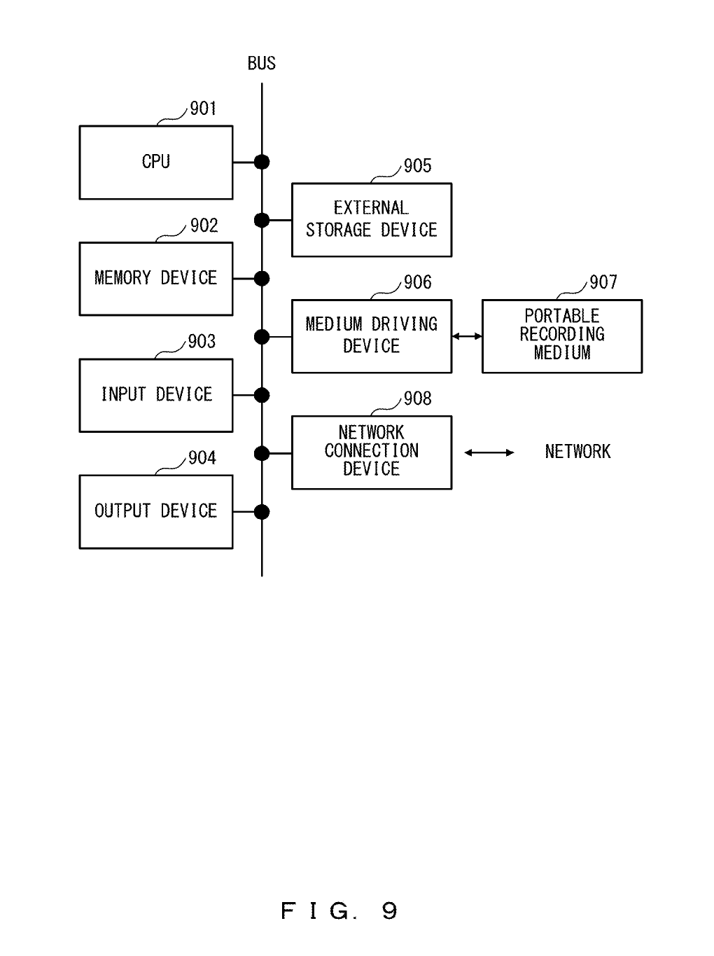

The browser monitoring unit 211 and the favorites information management unit 212 explained by referring to FIG. 2 may be implemented by, for example, making a CPU 901 execute a prescribed program. The CPU 901 will be explained by referring to FIG. 9. For example, when Internet Explorer (registered trademark) available from the Microsoft Corporation is used as the browser 220, WEB Browser control or the like maybe used as the browser monitoring unit 211 and the favorites information management unit 212. WEB Browser control is a standard control based on NET Framework 2.0 provided from the Microsoft Corporation.

When, for example, a function of obtaining the contents of a WEB page displayed by the browser 220 such as, for example, the URL, the title, the link information, or the like from the browser 220 is to be implemented by the browser monitoring unit 211, a program language that can use WEB Browser control can be used. Similarly, when a function or the like of displaying desired windows on the browser 220 is to be implemented by the favorites information management unit 212, a program language that can use WEB Browser control can be used. However, known techniques can be used as program languages that can use WEB Browser control, and thus detailed explanations thereof will be omitted.

As the temporary storage unit 213 and the favorites information storage unit 214 explained by referring to FIG. 2, a memory device 902 or an external storage device 905, which will be explained in FIG. 9, may for example be used. Note that although FIG. 2 illustrates the temporary storage unit 213 and the favorites information storage unit 214 as separate storage units, the temporary storage unit 213 and the favorites information storage unit 214 may also be implemented as a single storage unit as a matter of course.

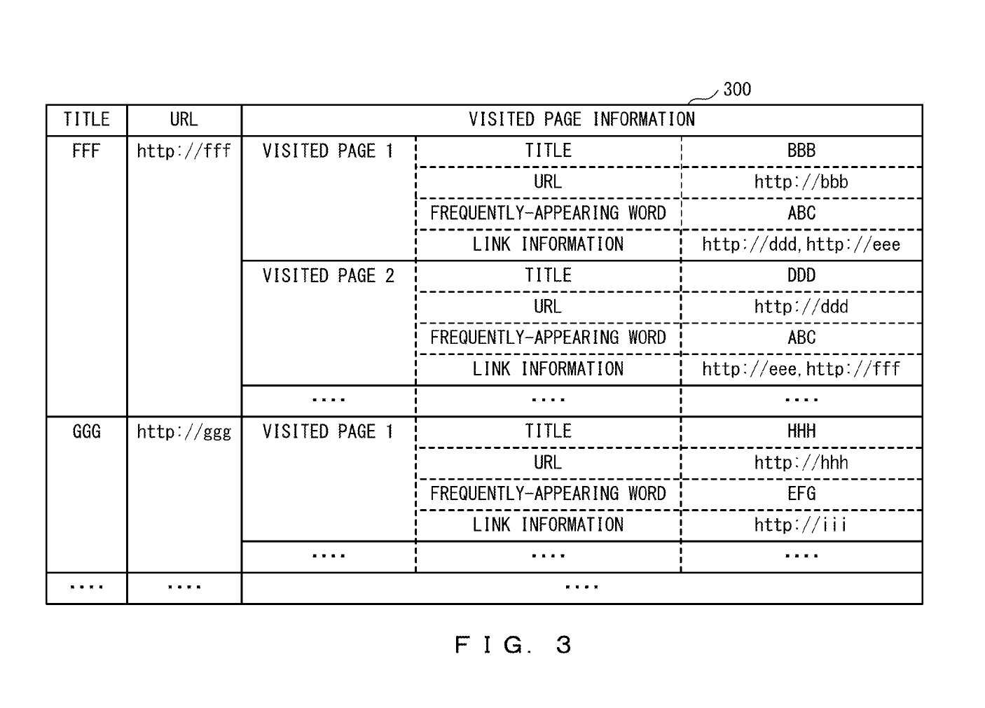

FIG. 3 illustrates an example of favorites information 300 stored in the favorites information storage unit 214.

The favorites information 300 includes the titles and the URLs of WEB pages stored as favorites information. Also, the favorites information 300 may include visited page information, i.e., information on a visited page, which is a

WEB page that was visited before the WEB page stored as the favorites information is reached. Also, a frequently appearing word may be a word that appears frequently in at least one character string of a particular word class among character strings included in a visited page.

Visited page information may include the title and the URL of a visited page, a frequently appearing word included in the visited page, link information included in the visited page, and the like. For example, FIG. 3 illustrates an example where the visited page information of visited page 1 includes the title “BBB”, the URL “http//bbb”, a frequently appearing word “ABC”, and link information “http://ddd, http://eee”. In the example illustrated in FIG. 3, only one frequently appearing word is displayed. However, this example is not intended to limit the scope of the present invention to a case where there is only one frequently appearing word. A plurality of frequently appearing words may be extracted from character strings included in a visited page.

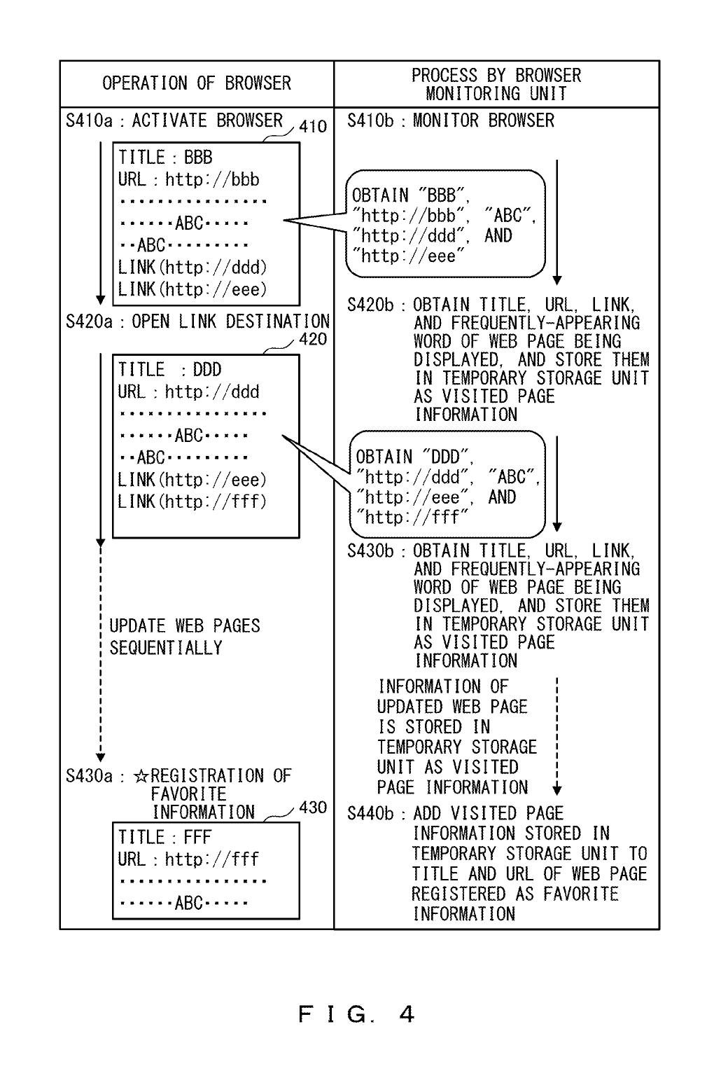

FIG. 4 illustrates the outline of a process performed by the browser monitoring unit 211.

The browser monitoring unit 211 monitors operations of the browser 220 (step S410b).

When the browser monitoring unit 211 has detected that the browser 220 outputs a WEB page to the display device 240 to display the page (step S410a), the browser monitoring unit 211 stores, in the temporary storage unit 213 as visited page information, information included in a WEB page 410 (step S420b) . This visited page information may include the title “BBB”, the URL “http/bbb” of the WEB page 410, a frequently appearing word “ABC” included in the WEB page 410, and link information “http://ddd, http://eee” included in the WEB page 410.

Also, when the browser 220 has opened a WEB page 420 (step S420a) as the link destination (http://ddd) in response to operations by a user, the browser monitoring unit 211 detects that the contents of the WEB page that the browser 220 outputs to the display device 240 to display have been updated. Also, the browser monitoring unit 211 stores information included in the WEB page 420 in the temporary storage unit 213 as visited page information (step S430b). This visited page information includes the title “DDD”, the URL “http://ddd”, a frequently appearing word “ABC” included in the WEB page 410, and link information “http://eee, http://fff” included in the WEB page 420.

As described above, each time the contents of a WEB page that the browser 220 outputs to the display device 240 to display are updated, the browser monitoring unit 211 stores information included in the updated WEB page in the temporary storage unit 213 as visited page information.

Also, the browser 220 stores a WEB page 430 being displayed in the favorites information storage unit 214 as favorites information in response to operations by a user (step S430a). In such a case, the browser monitoring unit 211 detects that the favorites registration button has been pressed, and adds, to favorites information, the visited page information that has already been stored in the temporary storage unit 213 in an associated manner (step S440b).

FIGS. 5A and 5B illustrates the outlines of display windows that the favorites information management unit 212 outputs to the display device 240 to display.

The favorites information management unit 212 displays a selection window 510 in response to a prescribed operation by a user (step S501).

The selection window 510 may include a list display button 511 and a frequently appearing word button 512. The list display button 511 displays in a listed manner all pieces of favorites information stored in the favorites information storage unit 214. The frequently appearing word button 512 displays in a listed manner only pieces of favorites information that include a particular frequently appearing word among pieces of favorites information stored in the favorites information storage unit 214. FIGS. 5A and 5B illustrates an example where the selection window 510 is displaying the frequently appearing word buttons 512 corresponding to frequently appearing words “ABC”, “BBB”, “DDD”, and “EFG”, respectively.

When the favorites information management unit 212 has detected that the list display button 511 was pressed, the favorites information management unit 212 obtains favorites information from the favorites information storage unit 214. The favorites information management unit 212 displays a list window 520 for the favorites information obtained from the favorites information storage unit 214 (step S502).

The list window 520 may include, for each piece of favorites information, the title and the URL of a WEB page stored as favorites information, and a frequently appearing word included in each visited page information of favorites information. Also, the list window 520 includes a content display button 521.

When the favorites information management unit 212 has detected that an arbitrary one of the frequently appearing word buttons 512 was pressed, the favorites information management unit 212 extracts favorites information including the frequently appearing word that corresponds to the frequently appearing word button 512 from among pieces of favorites information stored in the favorites information storage unit 214. Thereafter, the favorites information management unit 212 displays a list window 530 for the extracted piece of favorites information (step S503). The configuration of the list window 530 is the same as that of the list window 520.

The list window 530 illustrated in FIGS. 5A and 5B is an example of a list window displayed when the frequently appearing word button 512 corresponding to the frequently appearing word “BBB” has been pressed. Note that although only one piece of favorites information is displayed in the list window 530, this example is not intended to limit the number of pieces of favorites information that are displayed in the list window 530.

When the favorites information management unit 212 has detected that an arbitrary piece of favorites information displayed in the list window 520 was selected and the content display button 521 was detected, the favorites information management unit 212 displays a favorites information window 540 for the selected piece of favorites information (step S504).

The favorites information window 540 may include the title and the URL of the selected piece of favorites information. Further, the favorites information window 540 may include the URL included in visited page information included in the selected piece of favorites information, a detailed display button 541 for displaying the visited page information in detail, a frequently appearing word included in the selected piece of favorites information, and a re-search button 542. The re-search button 542 displays a search window 570 for executing a WEB search using as a search keyword the frequently appearing word being displayed in the favorites information window 540.

A URL or the like included in visited page information displayed in the favorites information window 540 such as, for example, “http://bbb” in the favorites information window 540 may be displayed as link information by using HTML (HyperText Markup Language). Thereby, users can easily refer to a visited page by selecting the URL of visited page information with a mouse or the like.

The favorites information window 540 illustrated in FIGS. 5A and 5B illustrates an example of a favorites information window for displaying the contents of the favorites information with the title “FFF” and the URL “http://fff” that have been selected in the list window 520. The favorites information window 540 illustrated as an example in FIGS. 5A and 5B is displaying visited page 1 having the URL “http://bbb” and visited page 2 having the URL “http://ddd”. The detailed display button 541 displayed next to the URL “http://bbb” of visited page 1 is a display button for displaying the visited page information of visited page 1 in detail. Similarly, the detailed display button 541 displayed next to the URL “http://ddd” of visited page 2 is a display button for displaying the visited page information of visited page 2 in detail. Also, the re-search button 542 displayed next to the frequently appearing words “ABC”, “BBB”, and “DDD” is a display button for displaying the search window 570 for executing a search using the frequently appearing words “ABC”, “BBB”, and “DDD” as search keywords.

When the favorites information management unit 212 has detected that the detailed display button 541 displayed in the favorites information window 540 was pressed, it displays a visited page window 550 for displaying the visited page information corresponding to the detailed display button 541 in detail.

The visited page window 550 may include the title and the URL included in visited page information. Also, the visited page window 550 may include link information included in visited page information, a frequently appearing word included in visited page information, and a re-search button 551. The re-search button 551 displays a search window 560 for executing a WEB search using as a search keyword the frequently appearing word being displayed in the visited page window 550.

Note that link information included in visited page information that is displayed in the visited page window 550, such as, for example, “http://ddd” or “http://eee” displayed in the visited page window 550 illustrated as an example in FIGS. 5A and 5B, maybe displayed by using HTML or the like. Thereby, users can easily refer to a WEB page specified by link information by selecting the link information with a mouse or the like.

When the re-search button 551 displayed in the visited page window 550 is pressed, the favorites information management unit 212 displays the search window 560 including a search keyword 561 and a search execution button 562 (step S506).

The search keyword 561 may use a frequently appearing word displayed in the visited page window 550. The favorites information management unit 212 displays the search keyword 561 in such a manner that users can edit it. When the search execution button 562 is pressed, the favorites information management unit 212 instructs the browser 220 to execute a WEB search using the search keyword 561 being displayed in the search window 560.

When the re-search button 542 displayed in the favorites information window 540 is pressed, the favorites information management unit 212 displays the search window 570 including a search keyword 571 and a search execution button 572 (step S507).

A frequently appearing word displayed in the favorites information window 540 may be used as the search keyword 571. The favorites information management unit 212 displays the search keyword 571 in such a manner that users can edit it. When the search execution button 572 is pressed, the favorites information management unit 212 instructs the browser 220 to execute a WEB search using the search keyword 571 being displayed in the search window 570.

As a matter of course, the selection window 510, the list windows 520 and 530, the favorites information window 540, the visited page window 550, and the search windows 560 and 570 illustrated in FIGS. 5A and 5B are only exemplary for display windows that the favorites information management unit 212 outputs to display, and are not intended to limit the scope of the present invention to the contents illustrated in FIGS. 5A and 5B.

Also, the selection window 510, the list windows 520 and 530, the favorites information window 540, the visited page window 550, and the search windows 560 and 570 illustrated in FIGS. 5A and 5B may be displayed by the browser 220 or may be displayed in a dedicated display window.

FIG. 6 is a flowchart for explaining operations of the browser monitoring unit 211.

When the browser monitoring unit 211 is activated (step S600), all pieces of information stored in the temporary storage unit 213 are deleted (step S601). Thereafter, the browser monitoring unit 211 determines at constant intervals whether or not the browser 220 is operating (NO in step S602).

When the browser 220 is operating (YES in step S602), the browser monitoring unit 211 determines at constant intervals whether or not the contents displayed by the browser 220 has been updated (NO in step S603).

When contents displayed by the browser 220 has been updated (YES in step S603), the browser monitoring unit 211 obtains from the browser 220 the title and the URL of the WEB page being displayed by the browser 220 (step S604).

Also, the browser monitoring unit 211 obtains the contents of the WEB page being displayed by the browser 220 so as to extract a frequently appearing word (step S605). In such a case, the browser monitoring unit 211 for example may divide text or the like included in the WEB page into particular character strings by utilizing morphological analysis or the like. Also, the browser monitoring unit 211 may extract a most-frequently appearing word for a particular word class such as, for example, a noun, a verb, or the like from among character strings obtained by the division.

The browser monitoring unit 211 stores in the temporary storage unit 213 (step S606) visited page information including the title and the URL obtained in step S604, the frequently appearing word extracted in step S605, and the link information included in the WEB page being displayed by the browser 220.

When the favorites information registration button of the browser 220 is not pressed (NO instep S607), the browser monitoring unit 211 repeats the processes of steps S602 through S607. When it has been detected that the favorites registration button of the browser 220 was pressed (YES in step S607), the browser monitoring unit 211 starts the process of step S608. In such a case, the browser monitoring unit 211 adds, in an associated manner, visited page information stored in the temporary storage unit 213 to favorites information stored in the temporary storage unit 213 by the browser 220 in response to the pressing of the favorites registration button (step S608). Thereafter, the favorites information management unit 212 starts the process from the step S601.

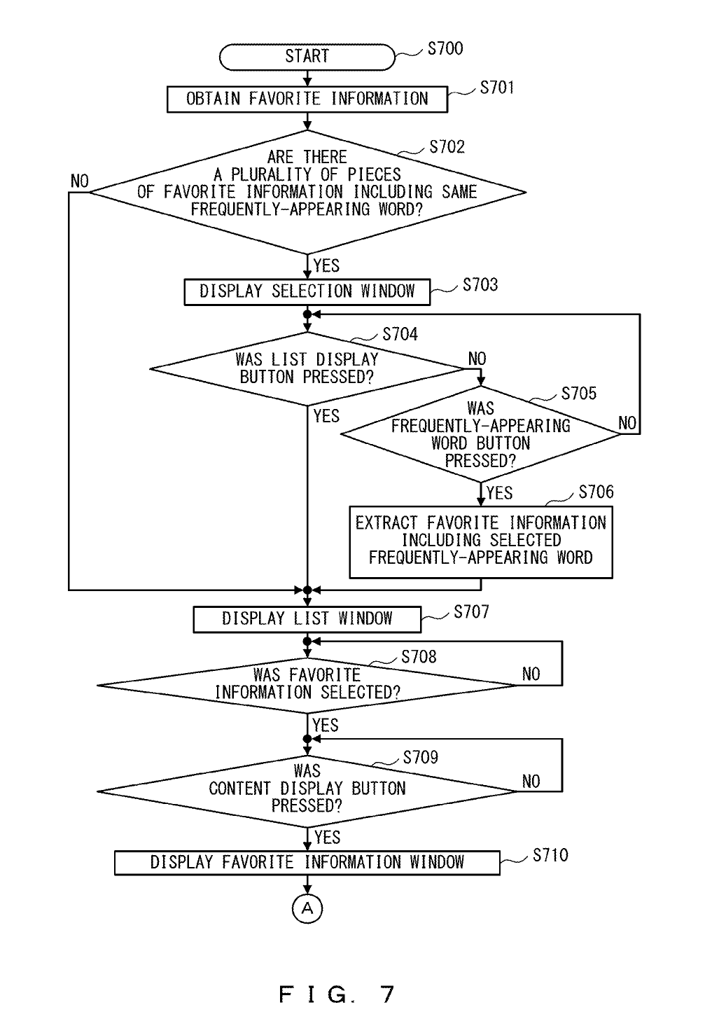

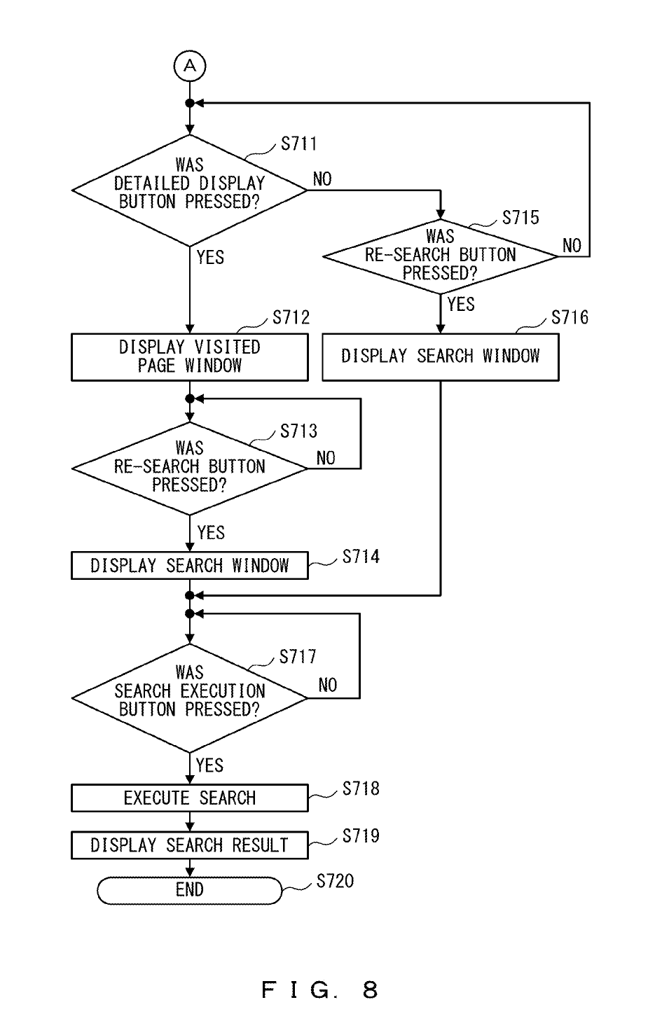

FIGS. 7 and 8 are flowcharts explaining operations of the favorites information management unit 212.

When a user has input a prescribed operation (step S700), the favorites information management unit 212 obtains favorites information from the favorites information storage unit 214 (step S701). When there are not a plurality of pieces of favorites information including the same frequently appearing word in the extracted favorites information (NO in step S702), the favorites information management unit 212 displays a list window of the favorites information obtained in step S701 (step S707).

When there are a plurality of pieces of favorites information including the same frequently appearing word in the extracted favorites information obtained in step S701 (YES in step S702), the favorites information management unit 212 displays a selection window (step S703). Thereafter, the favorites information management unit 212 waits until a list display button or a frequently appearing word button displayed in the selection window is pressed (NO in step S704 and NO in step S705).

When the favorites information management unit 212 has detected that a list display button displayed in the selection window was pressed (YES in step S704), the favorites information management unit 212 displays a list window of the favorites information obtained in step S701 (step S707).

When the favorites information management unit 212 has detected that an arbitrary frequently appearing word button displayed in the selection window was pressed (NO in step S704 and YES in step S705), the favorites information management unit 212 starts the process in step S706. In such a case, the favorites information management unit 212 extracts a piece of favorites information corresponding to the frequently appearing word button that has been detected to be pressed from the favorites information obtained in step S701 (step S706). Thereafter, the favorites information management unit 212 displays a list window for the favorites information extracted in step S706 (step S707).

After displaying a list window, the favorites information management unit 212 waits (NO in step S708) until an arbitrary piece of favorites information displayed in the list window is selected. When the favorites information management unit 212 has detected that an arbitrary piece of favorites information was selected in the list window (YES in step S708), the favorites information management unit 212 waits (NO in step S709) until a content display button displayed in the list window is pressed.

When the favorites information management unit 212 has detected that the content display button displayed in the list window was pressed (YES in step S709), the favorites information management unit 212 displays a favorites information window for the piece of favorites information selected in step S708 (step S710).

When the favorites information management unit 212 has detected that an arbitrary detailed display button displayed in the favorites information window was pressed (YES in step S711), the favorites information management unit 212 displays a visited page window for the visited page information corresponding to the pressed detailed display button (step S712). Thereafter, the favorites information management unit 212 waits (NO in step S713) until a re-search button displayed in the visited page window is pressed.

When the favorites information management unit 212 has detected that the re-search button displayed in the visited page window (YES in step S713) has been pressed, the favorites information management unit 212 displays a search window having as a search keyword a frequently appearing word displayed on the visited page window (step S714).

When the favorites information management unit 212 has detected that the re-search button displayed in the favorites information window was pressed (NO in step S711 and YES in step S715), the favorites information management unit 212 displays a search window having as a search keyword a frequently appearing word displayed in the favorites information window (step S716). Thereafter, the favorites information management unit 212 waits (NO in step S717) until the search execution button displayed in the search window is pressed.

Note that the favorites information management unit 212 can display a search keyword in such a manner that users can edit it. Thereby, users can adjust search keywords such as by adding new keywords, or deleting unnecessary keywords.

When the favorites information management unit 212 has determined that the search execution button displayed in the search window was pressed (YES in step S817), the favorites information management unit 212 instructs the browser 220 to execute a WEB search using a search keyword displayed in the search window (step S718). The browser 220 executes a WEB search, and displays the result of the search (step S719).

FIG. 9 illustrates a configuration example of the information management apparatus 210.

The information management apparatus 210 illustrated in FIG. 9 includes a CPU 901, a memory device 902, an input device 903, an output device 904, an external storage device 905, a medium driving device 906, and a network connection device 908. These devices are connected through a bus so that they can transmit and receive data to each other.

The CPU 901 is a computation device that executes a program for implementing the information management apparatus 210 according to the present example in addition to implementing peripheral devices and various types of software.

The memory device 902 is a volatile storage device used for executing programs. As the memory device 902, RAM or the like, for example, may be used.

The input device 903 is an external data input unit. As the input device 903, a keyboard or a mouse, for example, may be used. Users may press a list display button displayed in a selection window, edit a search keyword displayed in a search window, or perform other operations by using the input device 903.

The output device 904 outputs data and the like to the display device 240 or the like. The output device 904 may include the display device 240.

The external storage device 905 is a non-volatile storage device that stores programs for implementing the information management apparatus 210 according to the present example in addition to programs and data that the information management apparatus 210 needs to operate. As the external storage device 905, a magnetic disk storage device or the like for example may be used. Also, as the external storage device 905, a storage device connected through a network such as the Internet or the like, i.e., so-called online storage in the cloud, or the like may be used.

The medium driving device 906 is a device that outputs data of the memory device 902 or the external storage device 905 to a portable recording medium 907 such as, for example, a floppy disk, an MO disk, a CD-R, a DVD-R, or the like, or reads programs, data, or the like from the portable recording medium 907.

The network connection device 908 is a device to be connected to a network 909.

Note that as a recording medium that can be read by an information processing apparatus, such as the external storage device 905 and the portable recording medium 907, a non-transitory medium may be used.

Also, FIG. 9 illustrates an example of the configuration of the information management apparatus 210. Accordingly, the information management apparatus 210 may include arbitrary components not illustrated in FIG. 9 as needed. Also, the information management apparatus 210 may omit arbitrary components illustrated in FIG. 9 as needed.

In the above explanations, a WEB page has been used as an example of viewed information. The display device 240 has been used as an example of a display unit. The browser 220 has been used as an example of a viewing unit. Titles and URLs have been used as examples of identification information for identifying viewed information. A frequently appearing word has been used as an example of a frequently appearing character string included in viewed information. Visited page information has been used as an example of route information. The selection window 510 has been used as an example of a method of displaying first display information. The frequently appearing word button 512 has been used as an example of a first selection unit. The list window 530 has been used as an example of a method of displaying second display information.

Also, the obtainment unit, the extraction unit, the storage process unit, and the registration unit can be implemented by making the CPU 901 included in the information management apparatus 210 execute the processes in, for example, steps S604, S605, S606, and S608, respectively, in accordance with a prescribed program. Similarly, the first and second output units can be implemented by making the CPU 901 included in the information management apparatus 210 execute the processes in, for example, steps S703 and S705 through S707, respectively, in accordance with a prescribed program.

As described above, when a user has operated the browser 220 to register favorites information, the information management apparatus 210 adds, to the registered favorites information, visited page information on WEB pages that were visited before the user reached the registered information.

The information management apparatus 210 provides an interface such as, for example, the selection window 510 and the list windows 520 and 530 for categorizing pieces of favorites information for each frequently appearing word included in visited page information in order to allow them to be viewed.

Because a frequently appearing word included in a WEB page represents the abstract and characteristics of the WEB page, users can easily obtain desired favorites information even when there are a large number of pieces of favorites information. Also, a user can easily obtain desired favorites information even when he or she does not sort out piece of favorites information frequently.

The information management apparatus 210 provides an interface such as for example the favorites information window 540 illustrated in FIGS. 5A and 5B for viewing WEB pages that were visited before registered favorites information was reached. URLs, such as for example “http://bbb”, “http://ddd” or the like in the favorites information window 540 illustrated in FIGS. 5A and 5B, of visited page information included in the favorites information window provided by the information management apparatus 210 are displayed as link information by using HTML or the like. Accordingly, users can refer to WEB pages that he or she visited before reaching favorites information at any time.

The information management apparatus 210 provides an interface such as, for example, the favorites information window 540, the visited page window 550, and the search windows 560 and 570 illustrated in FIGS. 5A and 5B for executing a keyword search using as a search keyword a frequently appearing word included in favorites information. By executing a keyword search using as a keyword a frequently appearing word included in favorites information, users can obtain the latest information including the abstract of the contents and the characteristics of a WEB page registered as favorites information. Also, even when a link to a WEB page registered as favorites information has already been broken, the new link destination of the WEB page or a WEB page including the same or similar contents as the WEB page can easily be found.

The information management apparatus 210 provides an interface such as, for example, the search window 560 and the search window 570 illustrated in FIGS. 5A and 5B for executing a keyword search using a search keyword that has been edited as desired by users from a frequently appearing word included in favorites information. Users can execute a WEB search after editing a search keyword in the search windows 560 and 570 so that they can obtain contents related to the favorites information, information including more detailed contents about a portion included in the favorites information, and the like.

As described above, according to an aspect, it is possible to provide an information management apparatus and a method for managing information in which desired information can be easily obtained.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information management apparatus, comprising:
an obtainment unit to obtain identification information for identifying first viewed information when a viewing unit that obtains viewed information published on a network so as to output the viewed information to a display unit has displayed the first viewed information;
an extraction unit to extract a frequently appearing character string included in the first viewed information;
a storage process unit to store, in a storage unit, route information on the first viewed information that includes the identification information for identifying the first viewed information and the frequently appearing character string included in the first viewed information;
a registration unit to add route information to identification information for identifying second viewed information in an associated manner when the second viewed information being output from the viewing unit is to be registered as favorites information;
a first output unit to output to the display unit first display information for displaying a first selection unit that lists favorites information including route information including a frequently appearing character string for each frequently appearing character string included in the route information of the favorites information; and
a second output unit to output to the display unit second display information for displaying, in a listed manner, favorites information including route information including a frequently appearing character string that corresponds to a selected first selection unit when the first selection unit has been selected.

2. The information management apparatus according to claim 1, further comprising:
a third output unit to output to the display unit third display information for displaying a second selection unit that selects execution of a search using as a search keyword a frequently appearing character string included in the route information included in selected favorites information when the third output unit has detected that arbitrary favorites information included in the second display information has been selected.

3. The information management apparatus according to claim 2, wherein:
the third display information further includes a third selection unit that selects a display of detailed information of route information for each piece of route information included in the selected favorites information, and
the information management apparatus further includes a fourth output unit to output to the display unit fourth display information for displaying a fourth selection unit that selects execution of a search using as a search keyword a frequently appearing character string included in route information corresponding to a selected third selection unit when the third selection unit has been selected.

4. The information management apparatus according to claim 2, further comprising:
a fifth output unit to output to the display unit fifth display information for displaying, in an editable manner as a search keyword, a frequently appearing character string included in the third display information when the second selection unit has been selected, wherein:
the information management apparatus executes a search using as a keyword a frequently appearing character string included in the fifth display information or a frequently appearing character string after being edited when an instruction to execute a search has been received.

5. The information management apparatus according to claim 3, further comprising:
a fifth output unit to output to the display unit fifth display information for displaying, in an editable manner as a search keyword, a frequently appearing character string included in the fourth display information when the fourth selection unit has been selected, wherein:
the information management apparatus executes a search using as a search keyword a frequently appearing character string included in the fifth display information or a frequently appearing character string after being edited when an instruction to execute a search has been received.

6. The information management apparatus according to claim 2, wherein:
the third display information includes location information that represents a location of route information included in the selected favorites information, and when the location information has been selected, viewed information identified by the selected location information is output to the display unit.

7. The information management apparatus according to claim 1, wherein:
the second display information is display information for making the display unit display, in a listed manner, identification information for identifying second viewed information registered as favorites information and a frequently appearing character string included in route information of the favorites information in an associated manner for each piece of favorites information including route information including a frequently appearing character string corresponding to the first selection unit.

8. The information management apparatus according to claim 1, wherein:
the display unit is connected to the information management apparatus in a communicable manner through a network.

9. The information management apparatus according to claim 1, wherein:
the browser operates on an information processing apparatus connected to the information management apparatus in a communicable manner through a network.

10. An information management method comprising:
obtaining identification information for identifying first viewed information when a viewing unit that obtains viewed information published on a network so as to output the viewed information to a display unit has displayed the first viewed information;
extracting a frequently appearing character string included in the first viewed information;
storing, in a storage unit, route information on the first viewed information that includes the identification information for identifying the first viewed information and the frequently appearing character string included in the first viewed information;
adding, by using a processor, route information to identification information for identifying second viewed information in an associated manner when the second viewed information being output from the viewing unit is to be registered as favorites information;
outputting to the display unit, by using the processor, first display information for displaying a first selection unit that lists favorites information including route information including a frequently appearing character string for each frequently appearing character string included in the route information of the favorites information; and
outputting to the display unit, by using the processor, second display information for displaying, in a listed manner, favorites information including route information including a frequently appearing character string that corresponds to a selected first selection unit when the first selection unit has been selected.

11. A computer-readable recording medium having stored therein a program for causing a computer to execute a process for an information management, the process comprising:
obtaining identification information for identifying first viewed information when a viewing unit that obtains viewed information published on a network so as to output the viewed information to a display unit has displayed the first viewed information;
extracting a frequently appearing character string included in the first viewed information;
storing, in a storage unit, route information on the first viewed information that includes the identification information for identifying the first viewed information and the frequently appearing character string included in the first viewed information;
adding route information to identification information for identifying second viewed information in an associated manner when the second viewed information being output from the viewing unit is to be registered as favorites information;
outputting to the display unit first display information for displaying a first selection unit that lists favorites information including route information including a frequently appearing character string for each frequently appearing character string included in the route information of the favorites information; and
outputting to the display unit second display information for displaying, in a listed manner, favorites information including route information including a frequently appearing character string that corresponds to a selected first selection unit when the first selection unit has been selected.
